(19) United States
(12) Patent Application Publication
(10) Pub. No.: US 2013/0111869 A1
(43) Pub. Date: May 9, 2013

(54) Shield Apparatus for Agricultural Implement Header

(71) Applicants: Karl Victor Koch, Marsden (CA); Victor Demetrius Koch, Marsden (CA); Buddy Douglas Michel, St. Gregor (CA)

(72) Inventors: Karl Victor Koch, Marsden (CA); Victor Demetrius Koch, Marsden (CA); Buddy Douglas Michel, St. Gregor (CA)

(21) Appl. No.: 13/690,576

(22) Filed: Nov. 30, 2012

Related U.S. Application Data
(63) Continuation-in-part of application No. 13/313,639, filed on Dec. 7, 2011.
(60) Provisional application No. 61/496,203, filed on Jun. 13, 2011.

(51) Int. Cl. A01D 75/00

(52) U.S. Cl. CPC A01D 75/00
USPC 56/320.1; 56/375

(57) ABSTRACT

A shield apparatus is mounted on the header of an agricultural implement which includes a rotatable collecting member to direct collected material rearwardly towards a rear discharge opening. The shield apparatus includes a panel member and a mounting bracket assembly which supports the panel member above the rear discharge opening of the header spanning in a lateral direction transversely to the forward working direction such that the panel member extends from a rear edge rearward of the collecting member to a front edge which is spaced forward and upwardly in relation to the rear edge. The shield apparatus ensures that material thrown upwardly above the rear of the header frame is redirected downwardly into the rear discharge opening of the header for collection by the implement in the usual manner. The shield apparatus does not interfere with the visibility of the operator when the panel member is clear.

This application is a continuation in part of U.S. parent application Ser. No. 13/313,639, filed Dec. 7, 2011 which claims the benefit under 35 U.S.C. 119(e) of U.S. provisional application Ser. No. 61/496,203, filed Jun. 13, 2011.

### FIELD OF THE INVENTION

The present invention relates to a shield apparatus which extends upwardly and forwardly from a rear of a header frame of an agricultural implement header to direct material thrown upwardly by the rotating collecting member of header downwardly and inwardly towards a rear discharge opening of the header.

### BACKGROUND

A common construction of a header for an agricultural implement includes either a cutter bar with a pickup reel and/or a rotating tine pickup belt for feeding material to an auger which collects the material into a rear discharge of the header. In certain types of crops, material can be thrown upward onto the frame of the header above the rear discharge opening. The material can then obstruct the view of the operator of the implement, or become entangled in the implement, or be wasted by being thrown onto the ground instead of being collected in the usual manner of the implement.

### SUMMARY OF THE INVENTION

According to one aspect of the invention there is provided a shield apparatus in combination with a header of an agricultural implement arranged for movement across the ground in a forward working direction in which the header comprises a header frame arranged to be supported on the agricultural implement and at least one collecting member rotatably supported on the header frame so as to be arranged to direct collected material rearwardly towards a rear discharge opening laterally centered on the header, the shield apparatus comprising:

a mounting bracket assembly mounted onto the header frame; and

a panel member coupled to the mounting bracket assembly such that the panel member is supported above the rear discharge opening of the header spanning in a lateral direction transversely to the forward working direction;

the panel member being oriented such that a forward surface of the panel member extends from a rear edge which is positioned rearwardly of the collecting member to a front edge which is spaced forwardly and upwardly in relation to the rear edge in a working position.

The shield apparatus ensures that material thrown upwardly over the rear of the header frame is redirected downwardly into the rear discharge opening of the header for collection by the implement in the usual manner. By forming the panel member of a translucent or transparent material, the shield apparatus does not interfere with the visibility of the operator of the implement.

According to a further aspect of the present invention there is provided a shield apparatus in combination with a header of an agricultural implement arranged for movement across the ground in a forward working direction in which the header comprises a header frame arranged to be supported on the agricultural implement and at least one collecting member rotatably supported on the header frame so as to be arranged to direct collected material rearwardly towards a rear discharge opening laterally centered on the header, the shield apparatus comprising:

a mounting bracket assembly mounted onto the header frame; and

a panel member coupled to the mounting bracket assembly such that the panel member is supported above the rear discharge opening of the header spanning in a lateral direction transversely to the forward working direction;

the panel member being oriented such that a forward surface of the panel member extends from a rear edge which is positioned rearwardly of the collecting member to a front edge which is spaced forwardly and upwardly in relation to the rear edge in a working position;

the forward surface of the panel member being generally concave between the rear edge and the front edge thereof.

Preferably the mounting bracket assembly is arranged to support the panel member to be pivotal through a range of greater than 90 degrees. For example, the bracket assembly may be arranged to support the panel member at a plurality of different angular orientations of the panel member including a stored position in which the panel member projects generally rearwardly from said rear edge to said front edge.

The panel member may further include an upper flange portion secured along the front edge transversely to the forward surface of the panel member to project forwardly in the working position and a lower flange portion secured along the rear edge transversely to the forward surface of the panel member to project forwardly in the working position.

According to a second aspect of the present invention there is provided a shield apparatus in combination with a header of an agricultural implement arranged for movement across the ground in a forward working direction in which the header comprises a header frame arranged to be supported on the agricultural implement and at least one collecting member rotatably supported on the header frame so as to be arranged to direct collected material rearwardly towards a rear discharge opening laterally centered on the header, the shield apparatus comprising:

a mounting bracket assembly mounted onto the header frame; and

a panel member coupled to the mounting bracket assembly such that the panel member is supported above the rear discharge opening of the header spanning in a lateral direction transversely to the forward working direction;

the panel member being oriented such that a bottom surface of the panel member extends from a rear edge which is positioned rearwardly of the collecting member to a front edge which is spaced forwardly and upwardly in relation to the rear edge in a working position;

the bracket assembly being arranged to support the panel member at a plurality of different angular orientations of the panel member including a stored position in which the panel member projects generally rearwardly from said rear edge to said front edge.

Various embodiments of the invention will now be described in conjunction with the accompanying drawings in which:

### BRIEF DESCRIPTION OF THE DRAWINGS

FIG. 1 is a side elevational view of the shield apparatus supported on a pickup header.

FIG. 2 is a top plan view of the shield apparatus supported on the pickup header of FIG. 1.

FIG. 3 is a perspective view of one of the bracket members.

FIG. 4 is a side elevational view of the bracket member of FIG. 3.

FIG. 5 is a top plan view of the bracket member of FIG. 3.

FIG. 6 is a rear elevational view of the shield apparatus according to a second embodiment.

FIG. 7 is a side elevational view of one of the bracket members of the second embodiment in a first angular orientation of the panel member relative to the header.

FIG. 8 is a rear elevational view of the bracket member of FIG. 7 shown in the first angular orientation.

FIG. 9 is a side elevational view of the bracket member of FIG. 7 shown in a second angular orientation of the panel member relative to the header.

FIG. 10 is a rear elevational view of the bracket member of FIG. 7 shown in the second angular orientation.

FIG. 11 is an exploded side elevational view of a further embodiment of the shield apparatus.

FIG. 12 is a side elevational view of a further embodiment of the shield apparatus.

FIG. 13 is a perspective view of a rear side of a further embodiment of the shield apparatus.

FIG. 14 is a perspective view of a front side of the shield apparatus according to the embodiment of FIG. 13.

FIG. 15 is a rear elevational view of the shield apparatus according to the embodiment of FIG. 14.

FIG. 16 is a left side elevational view of the shield apparatus according to the embodiment of FIG. 14.

FIG. 17 is a right side elevational view of the shield apparatus according to the embodiment of FIG. 14.

In the drawings like characters of reference indicate corresponding parts in the different figures.

### DETAILED DESCRIPTION

Referring to the accompanying figures there is illustrated a shield apparatus generally indicated by reference numeral 10. The apparatus 10 is particularly suited for use with the header 12 of an agricultural implement, for example a harvester or the like, for movement therewith across the ground in a forward working direction.

The header 12 is attached to the front of the implement and typically comprises a header frame 14 having a rear discharge opening 16 laterally centered at the rear side thereof for communication with implement upon which the header is supported. An upper frame member 17 spans across the rear end of the header frame above the rear discharge opening. The header includes a collecting auger 18 which is rotatably supported on the header frame to direct collected material in the header rearwardly to the rear discharge opening.

In the illustrated embodiment, the header comprises a pick up header having a tine pickup member or reel 19 rotatably supported on the header frame spaced forwardly of the collecting auger for collecting material from the ground into the frame of the header for being subsequently directed by the collecting auger.

Alternatively, the header may comprise a straight-cut header including a cutter bar supported on the header frame supported forwardly of the collecting auger to cut the crop and collect the cut crop in the header frame for being subsequently directed by the collecting auger.

In either embodiment, the apparatus 10 generally comprises a rigid panel member 20 supported on the header frame by a bracket assembly comprises a plurality of bracket members 22 individually and independently supported on the header frame at spaced apart positions in a lateral direction across a rear of the header frame.

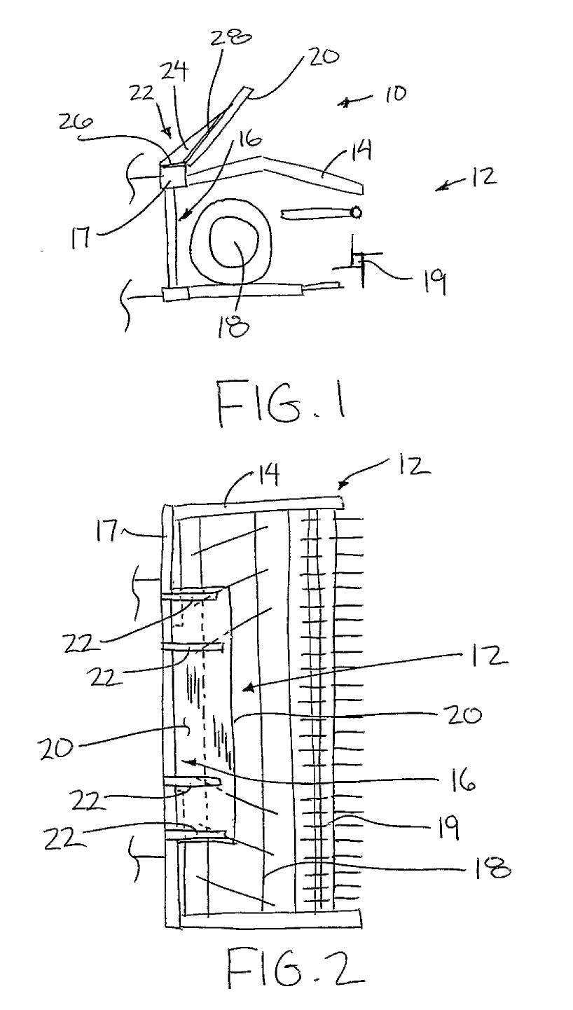

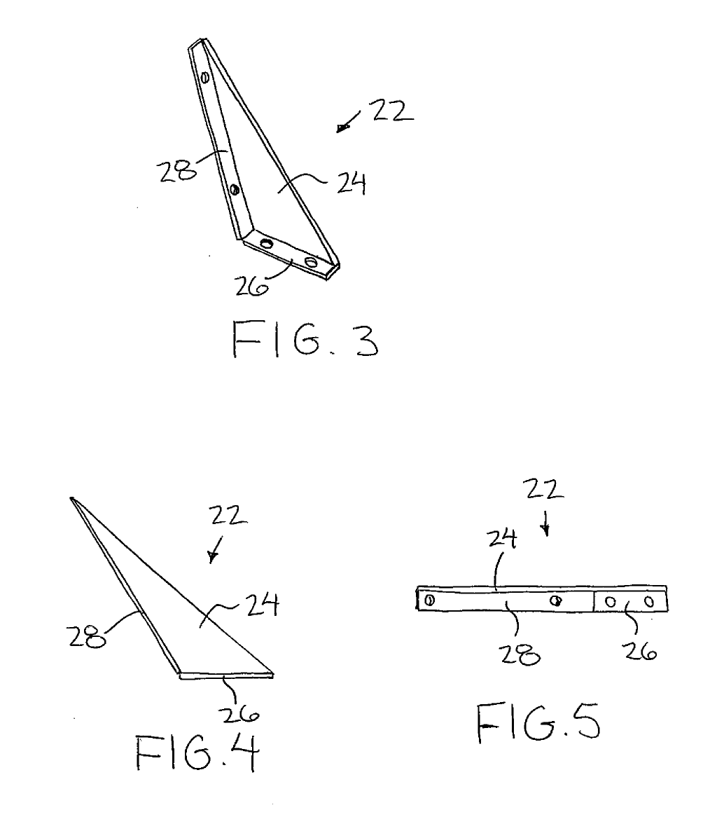

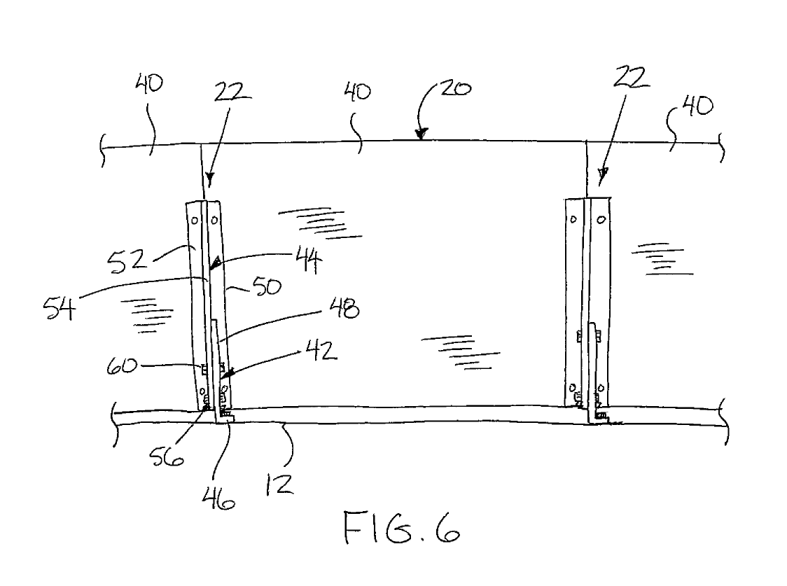

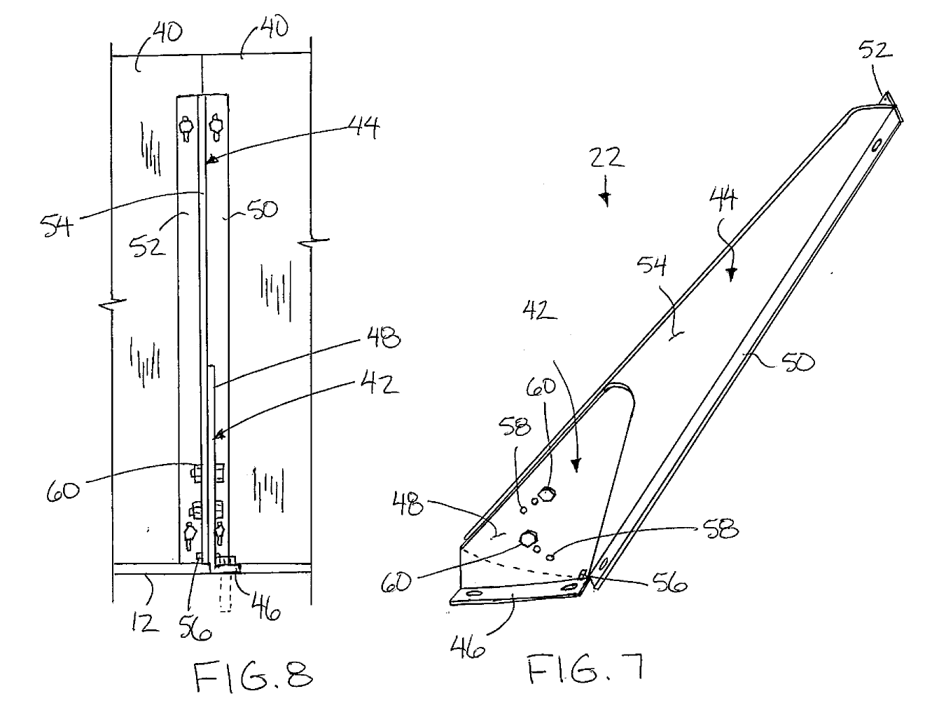

According to the first embodiment of FIGS. 1 through 5, each bracket member 22 is formed of a single sheet metal member which has been folded to define a triangular shaped main portion 24 having a first mounting flange 26 along one edge and a second mounting flange 28 along a second edge. The first mounting flanges 26 include fastener apertures receiving suitable fasteners therein such that the first mounting flanges are fastened to the top of the upper frame member 17 at the rear of the header frame in a releasable manner.

The bracket members are fastened such that the first mounting flanges lie in a horizontal plane across the top of the upper frame member 17 and such that the second mounting flanges lie in a common inclined plane locating the panel member 20 therein by fastening all of the second mounting flanges at respective laterally spaced apart positions on the panel member. The second mounting flanges and the panel member include co-operating apertures to receive threaded fasteners which couple the panel member to the respective mounting flanges.

The second mounting flanges are oriented at an inclination of near 40 degrees to the first mounting flanges such that the second mounting flanges and the panel member supported thereon extend forwardly at an upward inclination of near 50 degrees from horizontal in the illustrated embodiment. Typically the panel member is supported by the bracket members at an inclination in the range of 40 to 80 degrees, however other inclinations may be suitable.

The panel member of the first embodiment is formed of clear, rigid plastic material having dimensions of approximately 8 feet in length in the lateral direction across the header and a height of approximately 2 feet from a rear edge supported at the top of the upper frame member of the header to a front edge spaced upwardly and forwardly from the rear edge in the working position of the panel member.

Although the length of the header may be in the range of 14 to 16 feet for example, providing a panel member of approximately 8 feet in length which is mounted by the bracket members to be laterally centered, ensures that the panel member fully spans across an area above the rear discharge opening. The brackets adequately support the panel member such that it extends upwardly and forwardly from the rear edge supported on the top of the header frame at the rear side rearward of the collecting auger to a top or forward end which is spaced above the header frame, above the collecting auger and forward of the rear edge.

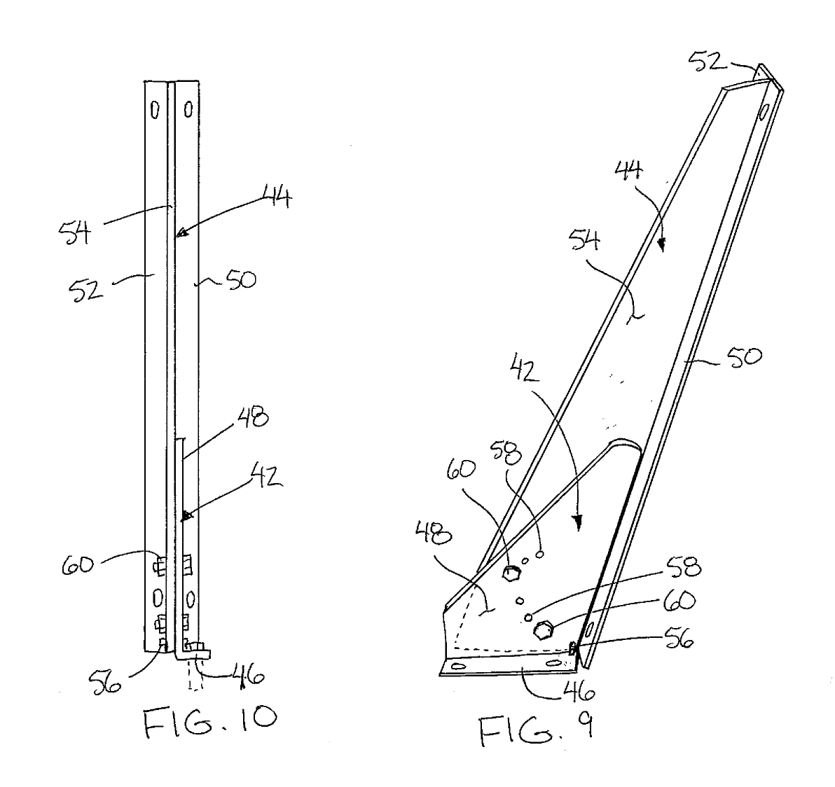

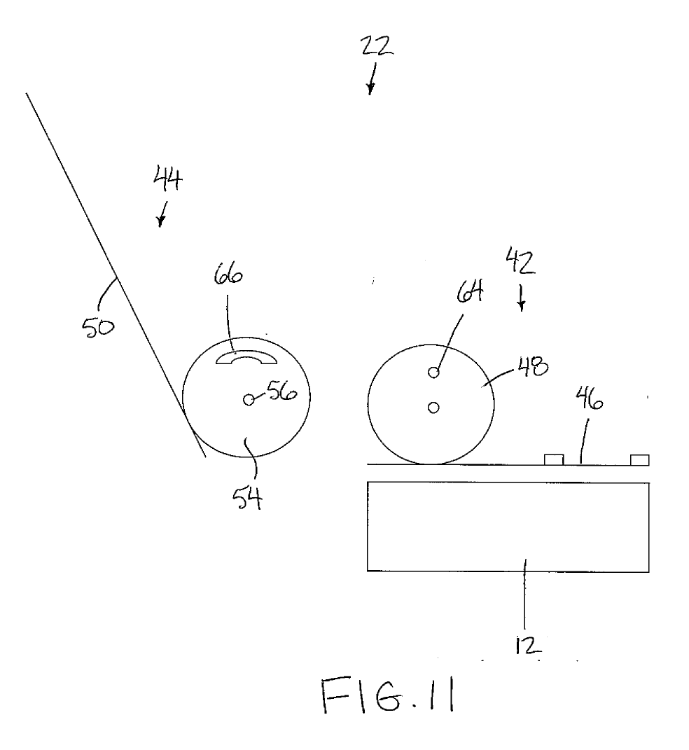

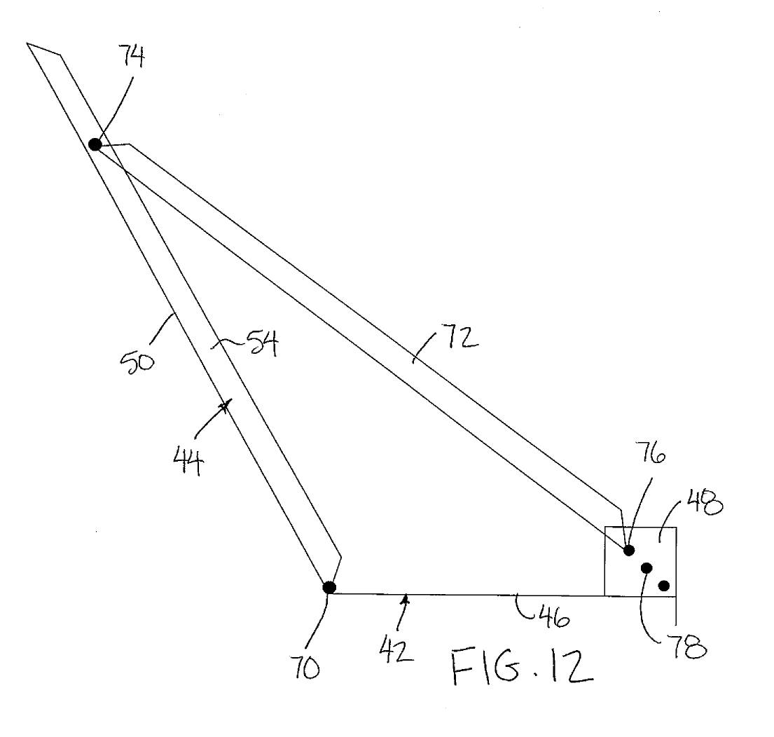

Turning now to FIGS. 6 through 10, a second embodiment of the bracket members 22 are shown. In this instance, the panel member 20 is again planar, but is formed in 3 separate panel sections 40 which are supported in series with one another in the lateral direction. Typically, four bracket members 22 are provided in this instance such that one bracket member is located adjacent each of the opposing ends of the assembled panel member with the remaining intermediate bracket members each being located at a junction between a respective adjacent pair of panel sections 40 abutted end to end with one another.

The bracket members 22 in this embodiment each include a base portion 42 and a panel portion 44 which are coupled together for relative movement such that the angular orientation of the assembled panel member can be adjusted relative to the header when the base portion is mounted on the upper frame member of the header and the panel portion is mounted on the panel members.

More particularly, each base portion 42 includes a base mounting flange 46 in the form of a plate member locating mounting apertures therein to permit fasteners to selectively secure the base portion to the header frame. The base portion further includes an upright pivot plate 48 fixed integrally with the mounting flange 46 in a substantially perpendicular relationship such that the upright pivot plate is oriented substantially vertically and parallel to the forward working direction of the header when the base mounting flange 46 is mounted horizontally across the top of the upper frame member of the header.

The panel portion of each bracket member includes a first panel mounting flange portion 50 which joins to one panel section of the panel member. At least the two intermediate ones of the bracket members 22 further include a second panel mounting flange portion 52. Accordingly, when the mounting bracket is located at the junction between an adjacent pair of panel sections, one panel mounting flange portion joins to one panel section while the other joins to the other panel section at the junction of the adjacent pair of panel sections by providing mounting apertures in both flange portions receiving suitable fasteners therethrough. The fastener apertures may be somewhat elongated to provide some relative adjustment of the panel sections relative to the corresponding flange portions of the panel portion 44. In this instance, the bracket members provide the dual function of joining the panel sections in abutment with one another to form the assembled panel member while also supporting the panel member at an adjustable angular orientation as described in further detail below.

Each panel portion 44 also includes an upright pivot plate 54 oriented perpendicularly to the first and second panel mounting flange portions 50 and 52 while being centered therebetween in the lateral direction such that the flange portions projects laterally outward from opposing sides of the upright pivot plate 54.

The upright pivot plates 48 and 54 are mounted parallel and directly adjacent to one another within each bracket member 22 such that the overlapping pivot plates are parallel to the forward working direction. A pivot pin 56 is coupled through cooperating apertures in the upright pivot plates to define a common horizontal axis extending through all of the bracket members in the lateral direction about which the panel member is pivotal relative to the header by permitting the panel portions of the mounting brackets to be pivotal relative to the respective base portions. The panel member is thus adjustable between a plurality of different angular orientations relative to the header.

The upright pivot plates also include two sets of cooperating apertures therein in which the cooperating apertures 58 are arranged to align with corresponding apertures in the other upright pivot plate adjacent thereto at a corresponding one of the different angular orientations of the panel member relative to the header. At each angular orientation, a suitable fastening member 60 is arranged to be received through the cooperating apertures to selectively fix the adjacent upright pivot plates relative to one another which in turn fixes the panel member relative to the header. In the illustrated embodiment of FIGS. 6 through 9 the two sets of cooperating apertures 58 in both upright plates correspond to three different angular orientations, for example 50 degrees, 60 degrees and 70 degrees from horizontal when the three different angular orientations are at equidistant intervals between 40 and 80 degrees. The two separate sets of cooperating apertures permit a fastener to be received through one corresponding aligned pair of apertures within each set for fixing the two upright pivot plates relative to one another at two spaced apart locations to adequately fix the panel member relative to the header at the selected orientation.

In the illustrated embodiment, both the upright pivot plates are generally triangular in shape and are further arranged such that the rear edges of both upright plates are aligned with one another in the lowest position of the panel member shown in FIG. 7 corresponding to the most horizontal position among the different angular orientations. Furthermore, the forward edges of both plate members are arranged to be aligned with one another in the most raised position in which the angular orientation is nearest to vertical as shown in FIG. 9.

In further embodiments, the fastening member 60 may comprise any suitable pin, bolt or clamp member which is arranged to selectively fix the two upright pivot plates 48 and 54 relative to one another about the pivot pin 56. In yet further embodiments, no pivot pin 56 is required to restrict the relative movement between the two upright pivot plates to a pivotal motion about a single axis when multiple sets of cooperating apertures are provided.

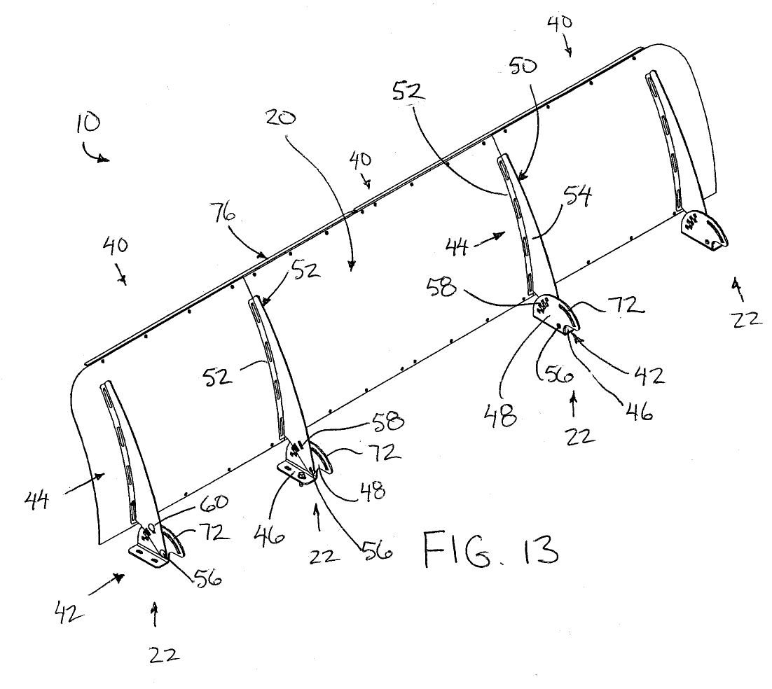

Turning now to FIG. 11, a further embodiment of the mounting brackets 22 is schematically represented. In this instance, the mounting bracket 22 is substantially identical to the previous embodiment with the exception of the upright pivot plates 48 and 54 being generally circular about the pivot pin 56. Furthermore, the cooperating apertures 58 in this instance comprise only a single aperture in one of the upright plates, that is the upright pivot plate 48 of the base portion in the illustrated embodiment, while the other upright pivot plate 54 defines the cooperating aperture as a single arcuate shaped slot of constant radius from the pivot pin. Accordingly the single aperture 64 remains aligned with the arcuate slot 66 throughout the full range of pivotal movement of the panel member relative to the header between the different angular orientations thereof.

In this instance, a suitable fastener 60 can remain secured within the single aperture 64 with only some loosening required to permit sliding of the fastener along the arcuate slot 66 to perform the angular adjustment. Tightening the fastener at the selected position frictionally clamps the two upright pivot plates together to again selectively restrict the angular orientation of the panel member at one selected orientation among a plurality of different angular orientations possible. The opposing ends of the arcuate slot define the opposing ends of the range of different angular orientations. The fastener 60 may also be replaced with any suitable clamp or bolt type fastener which permits sufficient frictional clamping force to be applied while remaining readily releasable for adjustment as desired.

Turning now to FIG. 12, according to a further embodiment of the bracket members, there may similarly be provided a base portion 42 including a base mounting flange 46 for fastening to the header frame as described above. Also, the panel portion 44 in this instance includes a similar first and/or second panel mounting flange portion 50/52 for fastening to the panel sections of the panel member. Also as in the previous embodiment, the panel portion includes an upright plate 54 integrally fixed therewith while the base portion mounting flange 46 includes an upright plate 48 integrally fixed therewith. The base mounting flange 46 and the mounting flange portions 50 and 52 in this instance however are directly coupled by a hinge 70 which defines the common horizontal pivot axis extending in the lateral direction about which the panel member is pivotal relative to the header.

The upright plates 48 and 54 in this instance instead define anchor plates rather than pivot plates which are arranged to lie spaced apart in a substantially common plane for fastening to opposing ends of an anchor member 72. The anchor member is a solid rigid member pivotally connected at a first end 74 to the anchor plate of the panel portion at a location spaced radially outward from the pivot axis. Similarly, the opposing second end 76 of the anchor member is arranged to be fastened to the upright anchor plate of the base portion 42 also radially spaced from the pivot axis so that the anchor member, the base portion, and the panel portion form a generally triangular configuration which fixes the orientation of the panel member relative to the header. The anchor plate of the base portion 42 however includes a plurality of anchor apertures 76 at spaced apart positions so that the second end 76 of the anchor member is anchored at different positions relative to the base portion corresponding to different angular orientations of the panel member relative to the header. Suitable fasteners fix the opposing ends of the anchor member to the base portion and panel portion respectively to selectively fix the panel portion relative to the base portion at the selected orientation. Typically, the range of desired angular orientations is consistent among the different embodiments.

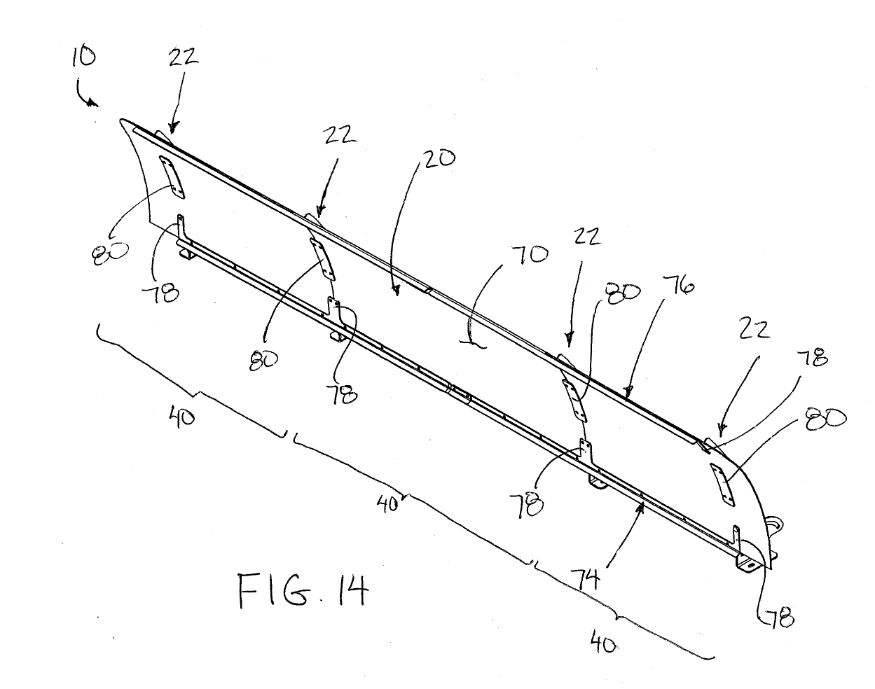

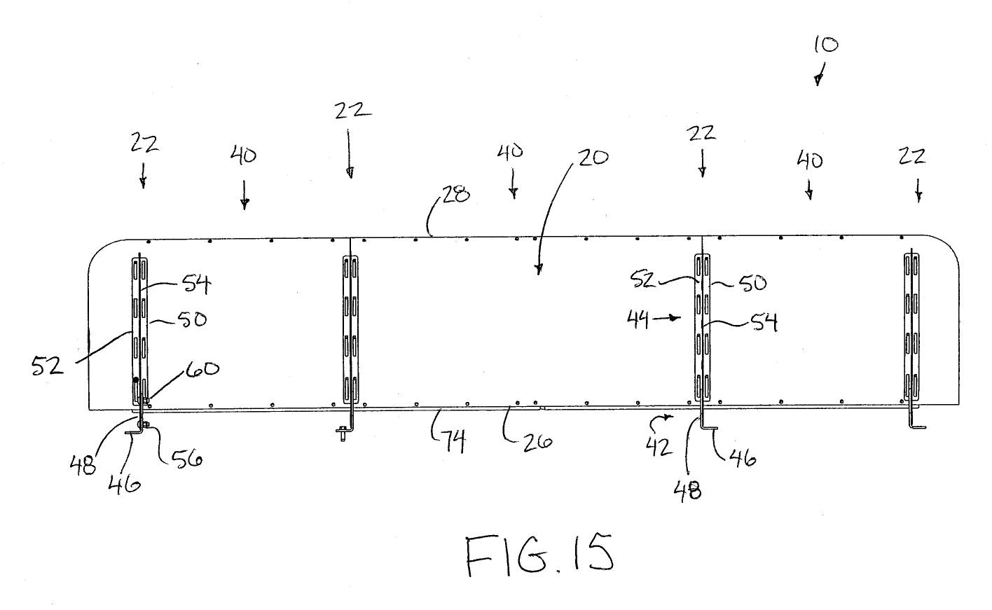

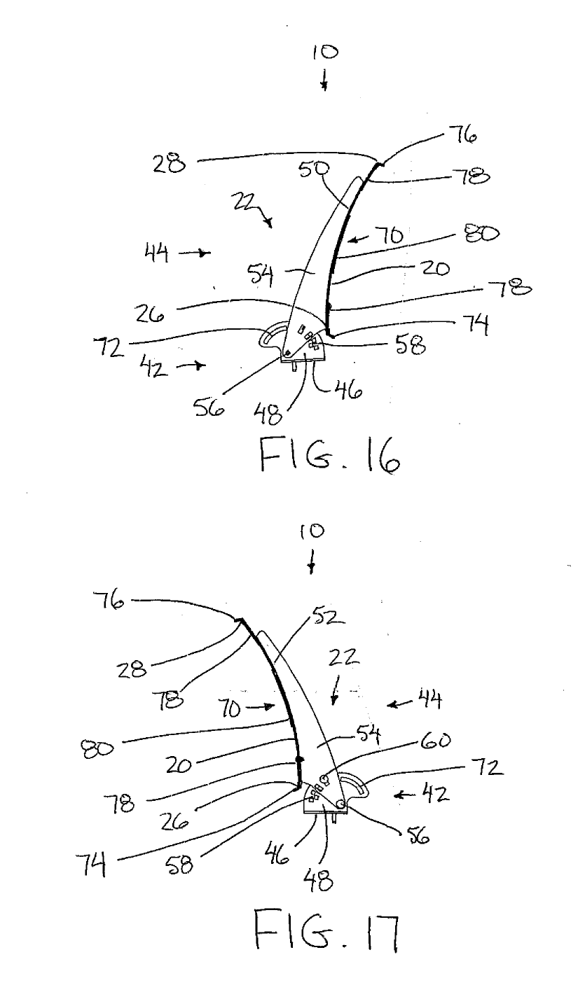

Turning now to the embodiment of FIGS. 13 through 17, the apparatus 10 is substantially identical with regard to the embodiment of FIGS. 6 through 10 noted above, with the exception of: i) the panel member 20 being non-planar; ii) an increased range of angular movement provided by the upright pivot plates 48 and 54 to include a stored position; and iii) additional support being provided by auxiliary support members described in further detail below.

As shown in FIGS. 13 through 17, the panel member in this instance includes a forward surface 70 which defines a working surface of the panel member spanning between the front and rear edges of the panel member. The forward surface generally faces forwardly and downwardly in the working position and is generally concave in shape between the rear and front edges of the panel member. The curved shape of the panel member enhances the ability of the panel member to redirect escaping material back into the header for collection. In view of the curved shape of the panel member, the forward edges of the pivot plates 54 of the panel portions of the brackets, as well as the panel mounting flange portions 50 and 52 are similarly curved for mating with the opposing rear surface of the curved panel member.

As further shown in FIGS. 13 through 17, the pivot plates 48 of the base portion 42 of each bracket member are generally semi-circular in shape about the pivot pins 56 defining the common pivot axis of the panel member relative to the header. In addition to the co-operating apertures 58 which receive fasteners 60 therethrough to secure the panel member fixedly at a selected one of plural different angular orientations, the pivot plates 48 of each base portion 42 further includes an auxiliary aperture in the form of a slot 72 which is arcuate about the axis of the pivot pin 56. The slot 72 aligns with one or more of the co-operating apertures 58 in the plate 54 of the panel portion 44 to receive one of the fasteners 60 therethrough while permitting some relative sliding of the fastener along the slot when loosened. The slot 72 permits the panel member to be supported in a stored position extending generally rearwardly in relation to the base portions of the bracket members from the bottom edge to the top edge of the panel member. The panel member thus extends rearwardly from the rear frame member 17 spanning across the top of the header so as to be out of use while still attached to the header if desired.

The auxiliary support members which provide additional support to the panel member are arranged to be engaged with the forward surface 70 of the panel member such that portions of each auxiliary support member are arranged to be aligned with corresponding portions of the first and second panel mounting flange portions 50 and 52 engaged with the opposing rear surface of the panel member. Fasteners are arranged to extend through corresponding apertures in the panel member to permit each fastener to be fastened between one of the first and second panel mounting flange portions 50 and 52 of a respective bracket member and a corresponding portion of a respective auxiliary support member to clamp a portion of the panel member therebetween.

The auxiliary support members include a lower member 74 and an upper member 76. The upper and lower member are rigid metal frame members which are connected across all of the bracket members to provide structural support and ensure that the bracket members are pivoted together with minimal stress applied to the clear plastic panel member material.

The lower member 74 includes a first flange which spans along the front surface of the panel member across all of the sections 40 adjacent the bottom/rear edge and a second flange defining a lower flange protruding from the first flange so as to be secured along the bottom/rear edge and so as to be oriented transversely to the forward surface of the panel member to project generally forwardly in the working position.

The upper member 76 includes a first flange which spans along the front surface of the panel member across all of the sections 40 adjacent the top/forward edge and a second flange defining an upper flange protruding from the first flange so as to be secured along the top/forward edge and so as to be oriented transversely to the forward surface of the panel member to project generally forwardly in the working position.

Each first flange of the upper and lower members also includes a fastening plate portion 78 in a generally common plane with the first flange which locate mounting apertures therein for alignment with the corresponding first and second panel mounting flange portions 50 and 52 to receive respective ones of the fasteners 60 therethrough. The fastening plate portions 78 protrude upwardly beyond a generally horizontal top edge of the first flange of the lower member and protrude downwardly beyond a generally horizontal bottom edge of the first flange of the upper member.

The auxiliary support members also include an intermediate member 80 associated with each bracket member in the form of a curved plate which lies flat against the front surface of the panel member for mounting between the corresponding fastening plate portion 78 of the upper member thereabove and the corresponding fastening plate portion 78 of the lower member therebelow. The intermediate member 80 includes fastener apertures therein in alignment with corresponding apertures in the corresponding first and second panel mounting flange portions 50 and 52 to receive respective ones of the fasteners 60 therethrough.

In this manner at least one uppermost fastener apertures in the panel mounting flange portions of each bracket member aligns with a fastener aperture in the upper member, at least one lowermost fastener aperture in the panel mounting flange portions of each bracket member aligns with a fastener aperture in the lower member, and at least one intermediate fastener aperture in the panel mounting flange portions of each bracket member aligns with a fastener aperture in a corresponding intermediate member 80.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A shield apparatus in combination with a header of an agricultural implement arranged for movement across the ground in a forward working direction in which the header comprises a header frame arranged to be supported on the agricultural implement and at least one collecting member rotatably supported on the header frame so as to be arranged to direct collected material rearwardly towards a rear discharge opening laterally centered on the header, the shield apparatus comprising:
a mounting bracket assembly mounted onto the header frame; and
a panel member coupled to the mounting bracket assembly such that the panel member is supported above the rear discharge opening of the header spanning in a lateral direction transversely to the forward working direction;
the panel member being oriented such that a forward surface of the panel member extends from a rear edge which is positioned rearwardly of the collecting member to a front edge which is spaced upwardly and forwardly in relation to the rear edge in a working position;
the forward surface of the panel member being generally concave between the rear edge and the front edge thereof.

2. The shield apparatus according to claim 1 wherein the mounting bracket assembly is arranged to support the panel member to be pivotal through a range of greater than 90 degrees.

3. The shield apparatus according to claim 1 wherein the bracket assembly is arranged to support the panel member at a plurality of different angular orientations of the panel member including a stored position in which the panel member projects generally rearwardly from said rear edge to said front edge.

4. The shield apparatus according to claim 1 wherein the panel member includes an upper flange portion secured along the front edge transversely to the forward surface of the panel member to project forwardly in the working position.

5. The shield apparatus according to claim 1 wherein the panel member includes a lower flange portion secured along the rear edge transversely to the forward surface of the panel member to project forwardly in the working position.

6. The shield apparatus according to claim 1 wherein the panel member comprises a transparent material.

7. The shield apparatus according to claim 1 wherein the mounting bracket assembly is arranged to support the front edge of the panel member at a greater height than the collecting member of the header.

8. The shield apparatus according to claim 1 wherein the mounting bracket assembly is arranged to support the panel member at a fixed inclination relative to the header frame.

9. The shield apparatus according to claim 1 wherein the mounting bracket assembly is arranged to support the panel member so as to be substantially centered in a lateral direction which is perpendicular to the forward working direction.

10. The shield apparatus according to claim 1 wherein the mounting bracket assembly includes mounting apertures formed therein so as to be arranged to be mounted onto the header frame using threaded fasteners such that the panel member is readily separable from the header.

11. The shield apparatus according to claim 1 wherein the mounting bracket assembly comprises a plurality of bracket members arranged to be independently coupled to the header frame at spaced apart positions in the lateral direction which is perpendicular to the forward working direction.

12. The shield apparatus according to claim 11 wherein each bracket member comprises:
a base portion including a base mounting flange fastened to the header frame and an upright pivot plate connected to the base mounting flange so as to be oriented substantially parallel to the forward working direction;
a panel portion including a panel mounting flange fastened to the panel member and an upright pivot plate connected to the panel mounting flange so as to be oriented parallel and adjacent to the upright pivot plate of the base portion;
the upright pivot plates of the base portion and the panel portion including cooperating apertures formed therein which are arranged to be aligned with one another at different angular orientations of the panel member relative to the header; and
at least one fastening member arranged to be received through the cooperating apertures at the different angular orientations so as to be arranged to selectively fix the panel member at a selected one of the different angular orientations relative to the header.

13. The shield apparatus according to claim 12 wherein the cooperating apertures are arranged to be aligned at a plurality of different angular orientations of the panel member throughout a range of greater than 90 degrees.

14. The shield apparatus according to claim 12 wherein the cooperating apertures are arranged to be aligned at a plurality of different angular orientations of the panel member including a stored position in which the panel member projects rearwardly from the base portion of the bracket members.

15. The shield apparatus according to claim 11 wherein each bracket member comprises:
a base portion including a base mounting flange fastened to the header frame;
a panel portion including a panel mounting flange fastened to the panel member, the panel portion being hinged to the base portion for relative pivotal movement about a common horizontal pivot axis of the panel member relative to the header; and
an anchor member arranged to be selectively anchored to both the base portion and the panel portion at respective locations spaced from the pivot axis at any one of a plurality of different angular orientations of the panel portion relative to the base portion corresponding to different angular orientations of the panel member relative to the header.

16. The shield apparatus according to claim 15 wherein the cooperating apertures are arranged to be aligned at a plurality of different angular orientations of the panel member throughout a range of greater than 90 degrees.

17. The shield apparatus according to claim 15 wherein the anchor member is arranged to be anchored at a plurality of different angular orientations of the panel member including a stored position in which the panel member projects rearwardly from the base portion of the bracket members.

18. A shield apparatus in combination with a header of an agricultural implement arranged for movement across the ground in a forward working direction in which the header comprises a header frame arranged to be supported on the agricultural implement and at least one collecting member rotatably supported on the header frame so as to be arranged to direct collected material rearwardly towards a rear discharge opening laterally centered on the header, the shield apparatus comprising:
a mounting bracket assembly mounted onto the header frame; and
a panel member coupled to the mounting bracket assembly such that the panel member is supported above the rear discharge opening of the header spanning in a lateral direction transversely to the forward working direction;
the panel member being oriented such that a forward surface of the panel member extends from a rear edge which is positioned rearwardly of the collecting member to a front edge which is spaced forwardly and upwardly in relation to the rear edge in a working position;
the bracket assembly being arranged to support the panel member at a plurality of different angular orientations of the panel member including a stored position in which the panel member projects generally rearwardly from said rear edge to said front edge.
